(19) United States
(12) Patent Application Publication
(10) Pub. No.: US 2017/0140605 A1
(43) Pub. Date: May 18, 2017

(54) Systems and Methods for Automatically Generating and Verifying Proposition Bets

(71) Applicant: SB Technologies Ltd., Belize City (BZ)

(72) Inventor: Ari LEWSKI, Caulfield South (AU)

(21) Appl. No.: 15/096,349

(22) Filed: Apr. 12, 2016

Related U.S. Application Data
(60) Provisional application No. 62/257,037, filed on Nov. 18, 2015.

(51) Int. Cl. G07F 17/32

(52) U.S. Cl. CPC G07F 17/323; G07F 17/3288

(57) ABSTRACT

Data containing user-defined terms for a proposition bet are received at a first network connected device, wherein the user-defined terms predict an outcome for the proposition bet. The user-defined terms may take the form of a performance condition for a proposition bet customized by a user; wherein the performance condition predicts an outcome for the proposition bet. A database is queried to retrieve historical data associated with the user defined terms for the proposition bet. The historical data is processed to generate odds that the user defined terms correctly predict the outcome for the proposition bet. The odds are transmitted to a second network connected device for acceptance or rejection by the user.

### TECHNICAL FIELD

The present disclosure relates to proposition bets, and in particular, systems and methods for processing customized proposition bets, including automatically generating proposition bet odds and verifying bet results.

### BACKGROUND

In most contexts, “proposition bet” denotes a bet made regarding the occurrence or non-occurrence during a game (usually a gambling game) of a performance condition not directly indicative of the game's final outcome. Proposition bets in sports are differentiated from the general bets for or against a particular team or contestant prevailing in a game/contest/match or regarding the total number of points scored. Traditionally, proposition bets can be made on performance conditions such as the number of strikeouts a pitcher will accumulate in a baseball game, whether a non-offensive player will score in an American football game, or which team will score the first points of the game.

### BRIEF DESCRIPTION OF THE DRAWINGS

FIG. 1 is a block diagram of a system configured to automatically generate and verify proposition bets, according to an example embodiment.

FIG. 2 is an illustration of a player selection console of a user interface of a system configured to facilitate customized bet creation, according to an example embodiment.

FIG. 3 is an illustration of a bet builder console of a user interface of a system configured to automatically generate and verify proposition bets, according to an example embodiment.

FIG. 4 is a flowchart illustrating a method for automatically generating proposition bets, according to an example embodiment.

FIGS. 5A-C are illustrations of a bet slip, a first bet confirmation screen, and a second bet confirmation screen, respectively, of a user interface of a system configured to automatically generate and verify proposition bets, according to an example embodiment.

FIG. 6 is a functional diagram of network controller of a system configured to automatically generate and verify proposition bets, illustrating a process of downloading data used to verify proposition bets, according to an example embodiment.

FIG. 7 is a functional diagram of network controller of a system configured to automatically generate and verify proposition bets, illustrating a process of parsing and mapping data used to verify proposition bets, according to an example embodiment.

FIG. 8 is a functional diagram of network controller of a system configured to automatically generate and verify proposition bets, illustrating a process of verifying proposition bets, according to an example embodiment.

FIG. 9 is a flowchart illustrating a process for automatically generating and verifying proposition bets, according to an example embodiment.

FIG. 10 is a block diagram of an apparatus configured to automatically generate and verify proposition bets, according to an example embodiment.

### DESCRIPTION OF EXAMPLE EMBODIMENTS

### Overview

The disclosed proposition betting system allows a user to create his or her own customized proposition bet on a wide range of individual performances (i.e., performance conditions) that may occur during an event, such as a sporting event, automatically generates the odds to offer the user for the customized bet, and then automatically verifies the results of the bet as soon as the outcome can be determined, e.g., without necessarily waiting until the underlying event concludes.

Example embodiments according to the apparatuses, systems and methods described herein may receive, at a first network connected device, data containing user-defined terms for a proposition bet, wherein the user-defined terms predict an outcome for the proposition bet. The user-defined terms may take the form of a performance condition for a proposition bet customized by a user; wherein the performance condition predicts an outcome for the proposition bet. A database is queried to retrieve historical data associated with the user defined terms for the proposition bet. The historical data is processed to generate odds that the user defined terms correctly predict the outcome for the proposition bet. The odds are transmitted to a second network connected device for acceptance or rejection by the user.

### Example Embodiments

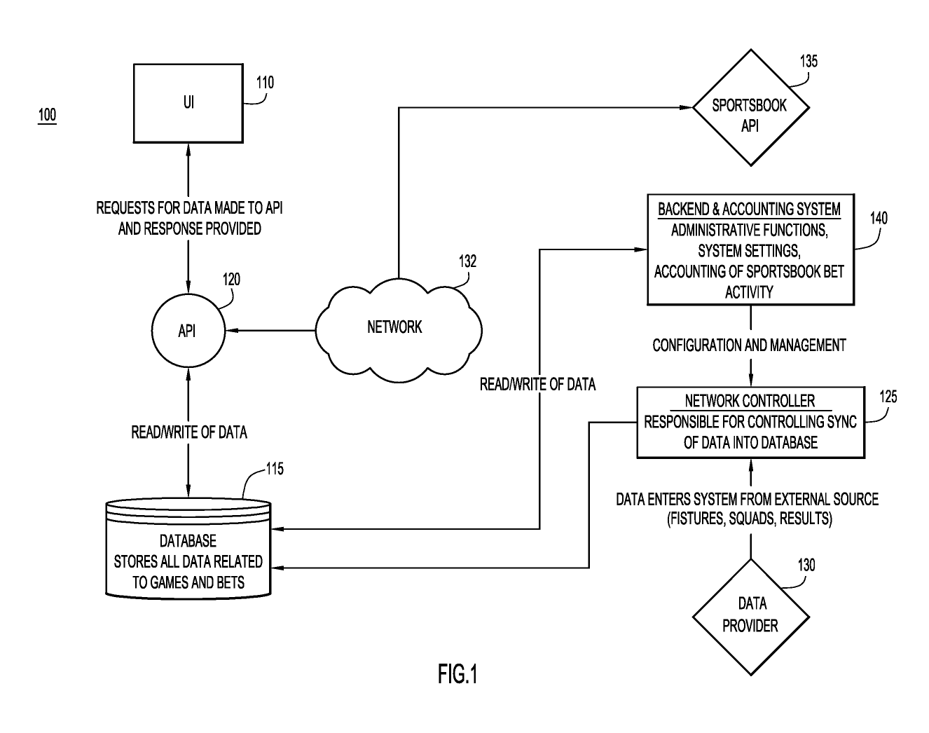

With reference made to FIG. 1, depicted therein is a system 100 configured to provide an automated customized proposition betting system. System 100 allows a user to create his own customized proposition bet on a wide range of performance conditions that may occur during an event, such as a sporting event, automatically generates the odds to offer the user for the customized bet, and then automatically verifies the results of the bet as soon as the outcome can be determined, e.g., without necessarily waiting until the underlying event concludes.

A proposition bet or “prop bet” is a bet relating to an occurrence or non-occurrence of some performance condition during an event. For example, during a sporting event, a “prop bet” may relate to the occurrence or non-occurrence of a statistical performance of one of the players or a comparative statistical performance of two or more players, without direct regard to the sporting event's final outcome. In the context of an awards show, a “prop bet” may include a prediction of the occurrence or non-occurrence of a performance condition other than the ultimate winner of a particular category. Furthermore, a “prop bet” can span multiple related or unrelated performance conditions. For example, a “prop bet” may include predicting a number of points scored by a player over a series of games, regardless of the actual outcome of any one of the games.

User interface 110 of the system enables the user to construct customized proposition bets. By way of a non-limiting example in the context of sporting events, the user can select a particular sport such as football (e.g., the National Football League), basketball (e.g., the National Basketball Association), hockey (e.g., the National Hockey League), soccer (e.g., the English Premier League or Major League Soccer), and baseball (e.g., Major League Baseball).

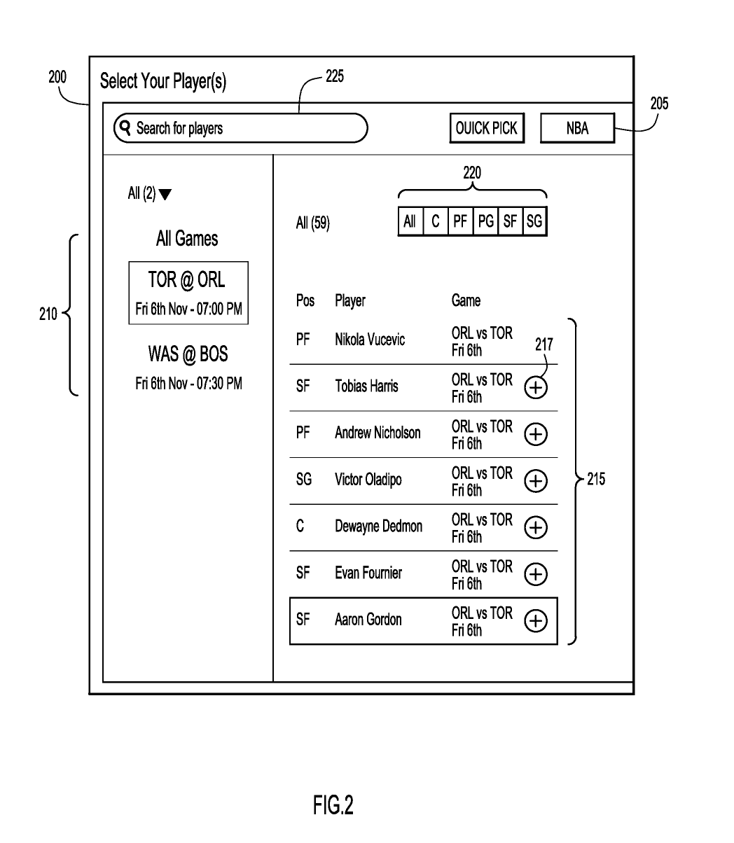

To select one or more players whose statistics will form the basis of the prop bet, the system may present a player selection console that enables the user to browse by event, position, or keyword search (which will be described in greater detail below with reference to FIG. 2). For example, the user may first be presented with the option to select a particular team, which enables the user to then select one or more players from a displayed team roster. According to another option, the user may be presented a list of upcoming sporting events, possibly filtered according to certain teams, from which the user can select the relevant sporting event and then one or more players from a displayed roster of players participating in the selected event(s). Various other filters may be presented to narrow the number of players listed, e.g., by position.

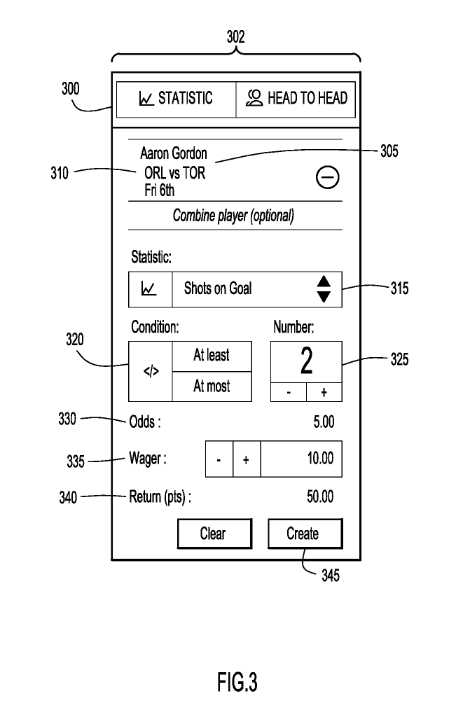

To further construct the customer prop bet, the system may also present the user with one or more “bet builder” consoles that display bet customization choices (which will be described in greater detail below with reference to FIG. 3). By way of example, the bet customization choices may include:
The type of bet (e.g., single statistics; combined statistics; head-to-head (H2H));
The statistic (e.g., filtered by position for certain sports, e.g., the NFL); and
Performance conditions (e.g., at least/at most for statistic bets; more/less for H2H).

For sports where players are categorized by position and statistics that are position specific (e.g., the NFL), the system will map statistics and make only the relevant ones available based on the player selected. In this context, if a quarterback is selected first, for example, only quarterback players will be available for selection as either a combined or head-to-head bet. Input values may also have min/max validations based on the statistic selected.

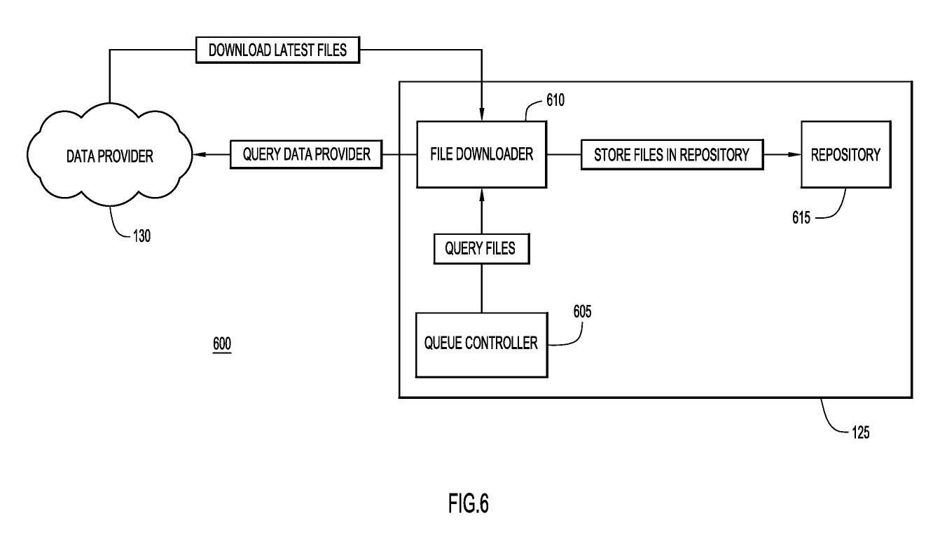

The system includes a database of information 115, including teams, players, sporting events, rosters of players, statistical categories, etc., that support generation of the display screens of user interface 110 for constructing the prop bet. Database 115 also stores bets created via user interface 110, as well as information used to verify the bets (as described in greater detail with reference to FIGS. 6-8).

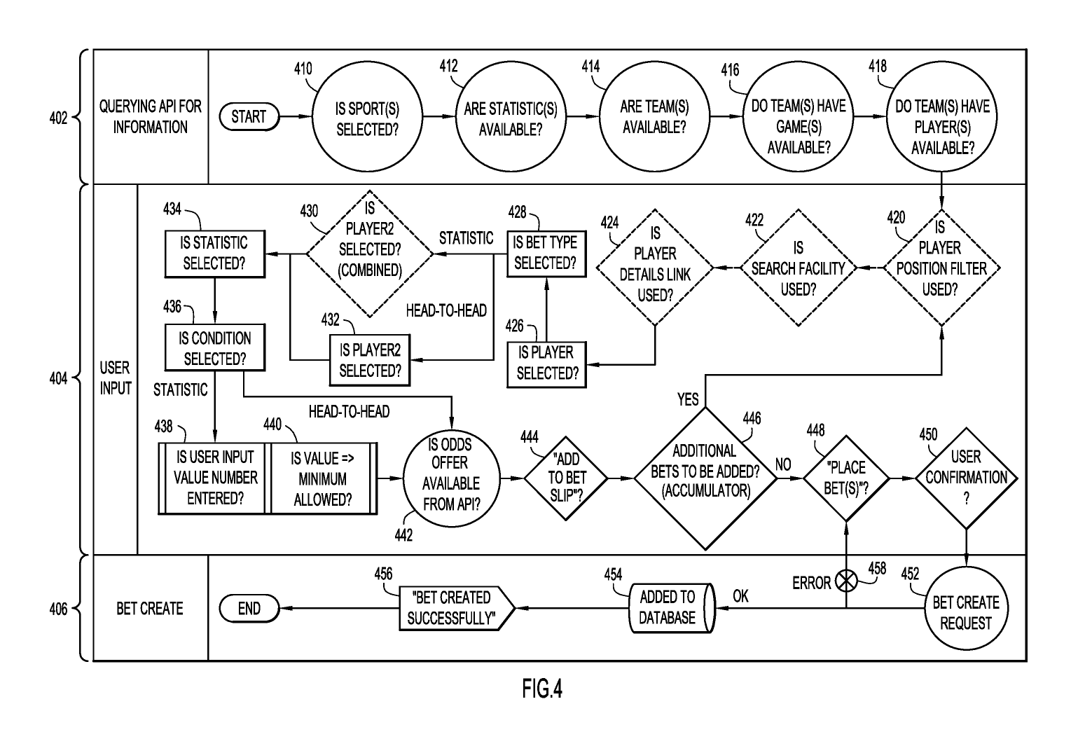

Application programing interface (API) 120 serves as an interface between user interface 110 and backend elements, such as database 115. For example, API 120 populates the fields of user interface 110 through one or more function calls that retrieve data from database 115 for display and use at user interface 110. Furthermore, once a bet is created through, for example, a player selection console and a bet builder console, API 120 communicates the user's desired bet to the necessary backend systems, as will be described in greater detail below with reference to FIG. 4

API 120 also generates odds in real time (i.e., near instantaneous odds generation) and presents the odds to the user once the parameters of the prop bet have been entered by the user. Based on the constructed prop bet, API 120 generates a “predicted” score for the player for a specific statistic. This score computation is performed by analyzing the player's historical statistical performance. For example, data illustrating the player's historical performances may be retrieved from database 115. According to one approach, a “weighted average” is computed from the retrieved data that takes into account the players most recent N games played, where N is a positive integer. For in-play odds generation, the methodology can be modified by analyzing current performance during the match and then using that same player's historical data to attempt to predict what score the player will achieve by some later point or by the end of the sporting event.

Next, using the same historical data set, API 120 may calculate the standard deviation of the player's statistical performance. Thus, a mean and standard deviation model of the player's expected performance for the selected statistic can be constructed from past performance data.

API 120 then applies a calculation methodology to determine the probability of the player achieving the selected numeric value of the prop bet statistic based on the player's expected performance model (e.g., ±1 unit greater than the expected value, ±2 units greater than the expected value, etc.). This probability may then be used to set the odds for the numeric value of the performance statistic selected by the user. Once calculated, the odds are transferred from API 120 to user interface 110, where the user has the option of accepting or declining the odds and bet.

Through the use of API 120, and the real-time odds/probability generation it provides, a system as illustrated in FIG. 1 may be used to present new ways of generating and accepting prop bets. Previously, a user would have been required to select from predetermined prop bets determined in advance by an odds maker. Through a system as illustrated in FIG. 1, a user may propose his or her own prop bet, and receive odds for the prop bet in real-time without interacting with a human odds maker. Furthermore, if the user is not satisfied with the odds, the user can immediately alter the conditions of the bet, and receive updated odds. If the user continues to be unsatisfied with the odds, the user may continually alter the conditions of the prop bet until the prop bet, including the odds, is to the user's liking. In other words, the real-time odds generation of the present disclosure allows a user to generate, modify and accept bets in a way for which there is no analogue in related fields and/or outside of the computer arts. Furthermore, by providing the odds in real-time, the user is able to see how the odds evolve with changes to the bet conditions, providing functionality previously unavailable when placing a prop bet. Additionally, as will be described below, bets may be generated “in-game,” i.e., new prop bets may be created based on a game, match or event that has already begun. Accordingly, the system of FIG. 1 presents new and novel ways of generating and accepting prop best.

In addition to generating odds for user-defined prop bets, API 120 may also be used to provide other services. For example, instead of generating odds for user defined bets, API 120 may be used to generate odds for predetermined packages of bet “markets.” For example, a bet market may be a package of pre-generated bets based upon the quarterback play of Tom Brady. Accordingly, API 120 may be programed to generate odds for Tom Brady at different levels of play, to generate the following market:
Brady Passes for No More Than 280 Yards at X:1 Odds
Brady Passes for No More Than 300 Yards at Y:1 Odds
Brady Passes for 350 or More Yards at Z:1 Odds.

Such a market may then be presented to users as part of user interface 110, allowing users to select one or more of the pre-calculated bets. Similarly, the bet markets may be provided to sportsbooks and casinos to allow their customer to accept the bets (e.g., via a data feed).

In order to ensure up-to-date data in database 115, network controller 125 is used to populate and manage the data contained in database 115. As will be described in greater detail with reference to FIG. 6, data from data providers 130 are downloaded, parsed and ultimately transmitted to database 115 by network controller 125.

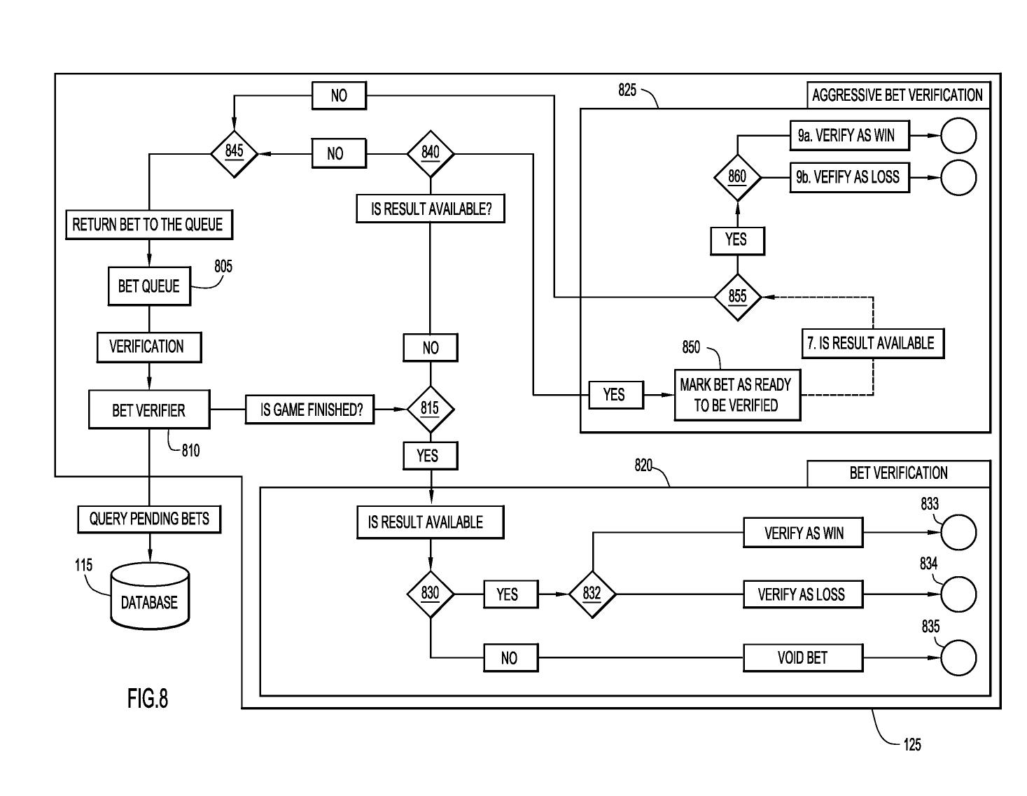

System 100, through network controller 125, may also provide bet verification. As used herein, bet verification is the process of determining the outcome of the bet, i.e., is the user a winner or loser of his or her bet. The present disclosure provides for different types of bet verification, including “aggressive” bet verification in which the outcome of a prop bet (win or lose) can be determined as soon as the bet conditions are definitively met or not met, without necessarily having to wait for the sporting event itself to conclude. The bet verification process performed by the system is summarized as follows, with a more detailed explanation provided below with reference to FIG. 8.

An external data provider 130, such as a statistics provider, maintains a real time or near real time database of performance statistics for all sporting events from which prop bets can be created. Network controller 125 maps the sporting fixture with dates and time, allowing network controller 125 to know when to start querying the statistics provider for updated statistic files. Periodically (intervals controlled through configuration), network controller 125 queries data provider 130, and parses the statistical information into database 115. Each sport has its own nuances in terms of how network controller 125 parses the data.

Network controller 125 periodically runs a process to determine whether any bets may be verified using parsed data. This process is essentially performed by comparing the customized bet condition (i.e., performance condition) and statistical performance hurdle with the live player statistical value parsed by the system. If an outcome can be determined from this comparison, then the bet is automatically verified at that point in time, resulting in bets being verified during live sporting events as play unfolds.

At the completion of a sporting event, network controller 125 waits for final “box score” files to come through from data provider 130 to resolve all remaining bets. These residual bets are for scenarios where a player, for example, has scored “0” which means the system then needs to determine whether the player did not play (bet marked as “Void”) or played but didn't score (marked as win/loss depending on bet condition).

Also included in system 100 is network 132 through which API 120 is connected to sportsbook API 135, and accounting system 140. API 120 may be configured to communicate with sportsbook API 135 via network 132 so that the sportsbook associated with sportsbook API 135 may be made aware of the current status of bets being made by users through user interface 110. Similarly, a casino sportsbook may utilize the odds generation functions of API 120 and or the bet verification functions of network controller 125. In order to access this functionality, sportsbook API 135 communicates with API 120 over network 132. API 120 may also communicate with sportsbook API 135 in order to communicate pre-packaged bet markets, as described above. Accounting system 140 may provide administrative functions, system settings, and accounting of sports book bet activity for API 120.

With reference made to FIG. 2, depicted therein is a player selection console 200 of a user interface, such as user interface 110 of FIG. 1. The user may construct his or her proposition bet on the network by utilizing a series of GUI elements. The GUI Elements of FIG. 2 are directed to selecting sporting events and players within those sporting events. These GUI elements include:
Sport selection button(s) 205
Game selection list 210
Player selection list 215
Player position filters 220
Player search bar 225

According to the example of FIG. 2, the user has selected “NBA” as the sport from sport selection button 205, and therefore, game selection list 210 is populated with NBA games. The user further selects “Toronto at Orlando” from the game selection list 210, and therefore, player selection list 215 is populated with players from the Toronto and Orlando NBA teams. If the user wishes to see only players of a specific position, one of the player position filters 220 may be selected, though in the example of FIG. 2, the user has elected to view “All” players. Accordingly, player selection list 215 includes all players from the Toronto and Orlando NBA teams. Also included in player selection list 215 are player detail buttons 217. Player detail buttons 217 allows a user to see more information for the player associated with the button. Finally, as illustrated in FIG. 2, the user has selected the player “Aaron Gordon” from the player selection list 215.

With reference now made to FIG. 3, illustrated therein is an example bet builder console 300. Bet builder console 300 allows a user to select the type of bet to be entered, as well as the statistics and criteria necessary to define a user's bet. In other words, bet builderconsole 300 allows the user to select a performance condition for the bet. For example, bet type selection area 302 allows the user to select a type of bet to make. FIG. 3 illustrates options for two types of bets—statistic bets and head-to-head bets. Other types of bets may include combined bets and accumulator bets. A statistic bet is a bet based on whether or not a single player will achieve a particular statistical value during a particular event or over a particular period of time. A combined bet allows the statistics of two or more players to be combined to reach a particular statistical value during a particular event or over a particular period of time. A head-to-head bet is a statistical bet between two different players, where the relative values of the statistic are compared for the two or more players. Finally, an accumulator is a combination or linking of two or more bets, such as a parlay or multiplier bet.

As shown, bet builder console 300 in this example displays the selected player(s) 305 and sporting event(s) 310, which may have been selected in a player selection console, such as player selection console 200 of FIG. 2. Bet builder console 300 enables the user to select a statistic (e.g., shots on goal) 315, a condition (e.g., “at least” or “at most”) 320, and the numeric value of the statistic (e.g., “2”) 325. The bet builder console 300 also displays the automatically generated odds 330 and enables the user to select the amount of the wager 335. Based on the odds 330 and the wager amount 335, the return on the prop bet 340 is also displayed. When the user is satisfied with the bet he has created, he may submit it to the API (e.g., API 120 of FIG. 1) by clicking on the Create Bet button 345.

With reference now made to FIG. 4, depicted therein is a process 400 for the creation of a bet through the use of, for example, API 120 of FIG. 1 and player selection console 200 and bet builder console 300 of FIGS. 2 and 3, respectively. Specifically, FIG. 4 illustrates the process of creating a bet in three portions: API query operations 402, user inputs 404 and bet creation steps 406. Once the process begins, a series of calls are made by the user interface to the API to populate the values in the user interface used to generate a bet. Specifically, operations 410-418 illustrate a plurality of GET calls to an API to retrieve the information used to generate bets. A GET call is a type of call that is used to retrieve data without directly modifying it. These GET calls retrieve the sports for which bets may be placed 410, a call to determine if statistics are available for the sports 412, a call to determine whether team values are available 414, a call to determine if game information is available for the teams 416, and a call to determine if player information is available for the teams 418. In other words, API calls 410-418 illustrate API calls to populate the user interface fields of player selection console 200 of FIG. 2 and bet builder console 300 of FIG. 3.

With the user interface populated by the get calls of operations 410-418, the user actions and consistency checks regarding the user actions are performed through operations 420-450. Operations 420, 422 and 424 are operations performed by the user interface to determine whether optional functions within the user interface have been performed. Specifically, operation 420 determines whether the user has elected to use a player position filter, such as player position filter 220 of FIG. 2, operation 422 determines whether the user has used a search function, such as search bar 225 of FIG. 2, and operation 424 determines whether a user has selected a player detail button, such as player detail button 217 of FIG. 2. The user interface is appropriately updated to reflect the outcomes of operations 420-424.

Operation 426 determines whether the user has selected a player to associate with his or her bet. Similarly, in operation 428, it is determined whether or not a bet type has been selected. Related to the selection of a player in operation 426 and bet type in operation 428, operations 430 and 432 determine if a second player is selected for specific types of bets. In operation 430, it is determined whether or not a second player has been selected for a bet that relies on the combined statistics for the two or more players. In operation 432, it is determined whether a second player has been selected for a bet that is based upon the head-to-head performance of two different players.

Operations 434 and 436 determine whether the specific statistic (e.g., “shots on goal,” “number of points,” etc.), and the condition (“greater than, “less than,” etc.) have been selected, respectively. Operations 438 and 440, on the other hand, ensure that the user's value associated with the statistic has been entered (operation 438) and that the value meets certain criteria, such as being above certain minimum values or below certain maximum values (operation 440). Operations 438 and 440 may sometimes be skipped, such as for a head-to-head bet, when the relatively performance of two players is compared regardless of the actual values the players achieve.

In operation 442 it is determined whether or not odds are available for the bet based upon the criteria selected in operations 426-440. If odds are available, they are displayed to the user through, for example, generated odds portion 330 of FIG. 3. Operation 442 may take the form of an API GET call. This API GET may also combine with other operations, such as operation 440. Specifically, it may not be known until the GET call is made what the minimum statistical value for a particular bet is. Accordingly, the determination of operation 440 may be included in the GET call of operation 442.

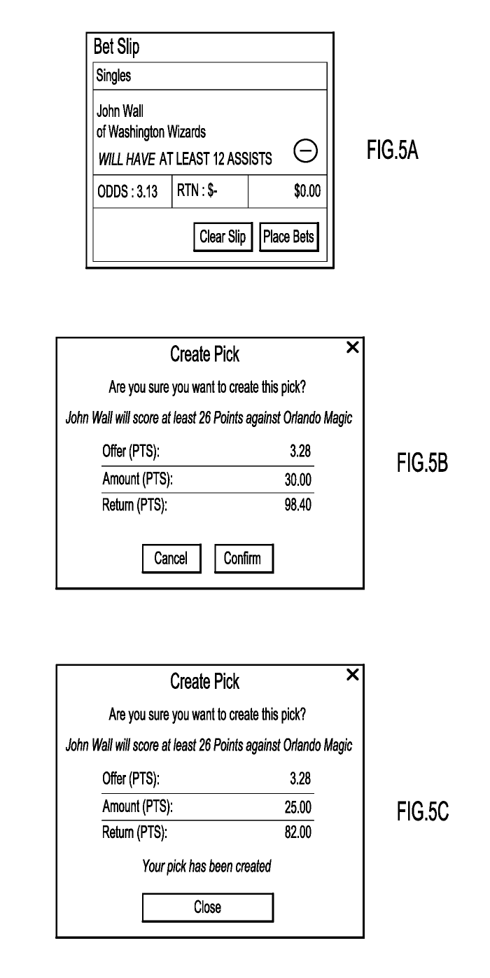

In operation 444, the user accepts the odds through, for example, selection of create bet button 345 of FIG. 3. The acceptance of the odds may add the user's bet to a “bet slip,” an example of which is illustrated in FIG. 5A. A bet slip is an indication of the bets that a user has made, and includes the following information:
Bet Selection Type
Bet Details (e.g., the performance condition)
Potential Winnings and Wager
Proceed/cancel buttons

If the user would like to make further bets, operation 446 returns the process to operation 420, and the process repeats until the user has finished making bets. Once the user has finished making bets, the user indicates that the bets should be placed through operation 448. Finally, in operation 450, the user provides a confirmation that the bet should be placed. The confirmation provided by the user may take the form of an additional user interface console, such as the bet confirmation screen illustrated in FIG. 5B. Returning to FIG. 4, once the user confirms the bets in operation 450, an API POST call may be used to place the bets. A POST call is an API call that is used to record or finish recording new data. Accordingly, the POST call of operation 448 contains all of the information and criteria necessary to define the user's bet. Specifically, the information/criteria included in the POST call may include all of the information acquired and/or verified in operations 426-442 for each bet the user has entered. Because different types of bets require different criteria, different POST calls may be used when posting a particular bet. For example, operation 448 may make a different POST call depending on whether the bet being placed is a statistic bet, a head-to-head bet, a combined bet or an accumulator bet.

As illustrated in operation 452, the API POST initiated in operation 450 initiates a bet create request in, for example, API 120 of FIG. 1. Specifically, the API validates the data received in the API POST call in operation 452 and enters the bet into a database, such as database 115 of FIG. 1, in operation 454. The user is notified in operation 456 through, for example, the bet confirmation screen of FIG. 5C. On the other hand, if the validation of operation 452 fails, the user will be notified of an error in operation 458.

With reference now made to FIG. 6, depicted therein is functional diagram 600 of functional units of a network controller, such as network controller 125 of FIG. 1, that may be used to verify the results of bets placed according to a process like that of FIG. 4. As illustrated in FIG. 6, included in network controller 125 are a queue control 605, a file downloader 610 and a repository 615. Queue controller 605 generates download requests for file downloader 610 to download files from a data provider 130. The download requests may be broken down into individual requests by game, team, league schedule, and/or other criteria that serve as criteria for the bets generated according to the process of, for example, FIG. 4. The download requests may be sent to file downloader 610 according to a predetermined schedule. This schedule may be based on, for example, a predetermined game schedule, and/or specific events, such as the presence of a user bet that includes particular download criteria. The download requests may be generated in the form of a database query, defining the data to be downloaded according to a query language, such as Structured Query Language (SQL). Once a download request is received at file downloader 610, the data provider 130 is queried by file downloader 610. After receiving a download file, the downloaded data is sent to repository 615 where it is stored. Repository 615 may retain the data according to version control procedures.

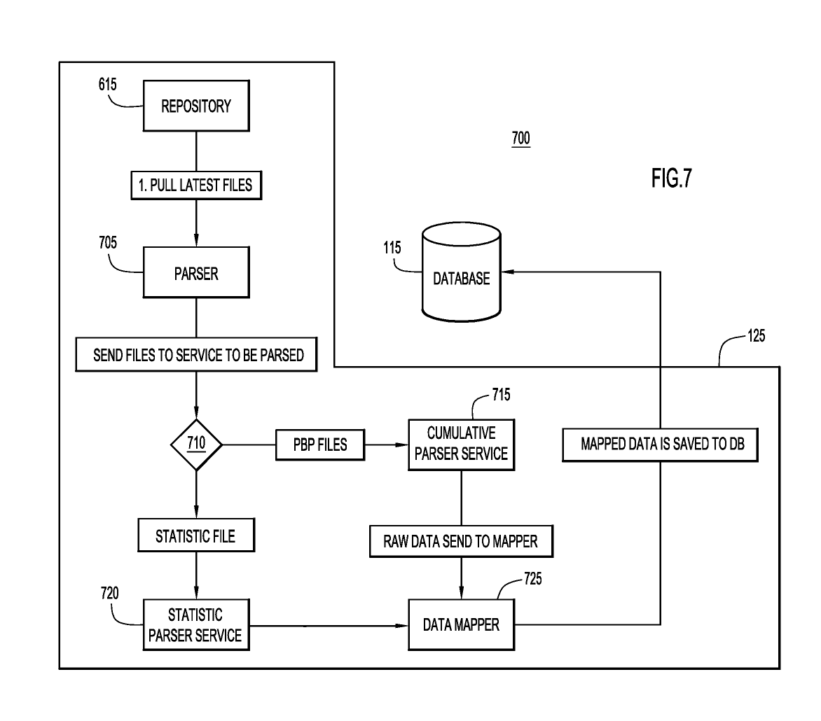

With reference now made to FIG. 7, depicted therein is a second functional diagram 700 of functional units of a network controller, such as network controller 125 of FIG. 1. Specifically, functional diagram 700 illustrates the processes by which the data downloaded according to FIG. 6 is loaded into, for example, database 115 of FIG. 1, and subsequently used to verify bets made by users according to, for example, FIG. 4. After the data is downloaded according to FIG. 6, parser 705 retrieves the latest data from repository 615. Depending on the type of file retrieved from repository 615, parser 705 will send the data file to one or more parser services. For example, some data files downloaded according to the process of FIG. 6 may be play-by-play files. These files include data that describes how a game, match or contest develops based upon individual plays or performance conditions. Play by-play data is sent to cumulative parser service 715 which accumulates the play-by-play data over the course of the game, match or contest. In other words, because play-by-play data includes statistic data for every play within the game, such data is sent to a parser that is configured to sum or other wise aggregate the values to determine total statistic value for the game, match or contest. On the other hand, data files that already include data for an entire game, match or contest, such as box score data, is sent to statistic parser service 720.

Once the data is parsed, parsers 715 and 720 send the raw parsed data to data mapper 725. Data mapper 725 converts or maps the data from the format received from parsers 715 and 720 into a format that can be used by database 115. For example, data mapper 725 maps the unique identifiers used in the data files as received from a data source (such as data provider 130 of FIGS. 1 and 6) to the unique identifiers used by database 114. Data mapper 725 also creates data bindings between input data and locally stored values, such as players, teams, and/or games, to be used later for continued parsing and subsequent data updates. In other words, data providers may use unique identifiers attached to players, teams and/or games. The identifiers may not be the same identifiers used by other data providers and/or used by database 115. For example, “Player A” may have a unique identifier of “123” assigned by a data provider, while database 115 uses an identifier of “456” for the same player. Data mapper 725 will store data that maps the data source identifier of “123” to the local identifier of “456,” and convert the identifier for “Player A” to “456” before transmitting the data to database 115. Once mapping has been completed, data mapper 725 transfers the data to database 115 for storage in database 115.

With reference now made to FIG. 8, depicted therein are functional units of a network controller, such as network controller 125 of FIG. 1 that implement a process for carrying out bet verification. Specifically, FIG. 8 illustrates two different ways in which bets are verified according to the techniques described herein: bet verification and aggressive bet verification. The process illustrated in FIG. 8 begins when bet queue 805 queries database 115 for the bets entered into database 115 by, for example, the process illustrated in FIG. 4. Bet queue 805 may query database 115 for all pending bets, i.e., all bets that have not been previously verified according to the process to be described with reference to FIG. 8. The pending bets are sent to bet verifier 810, where it is first determined at operation 815 whether or not the event (e.g., contest, game, match, season, etc.) upon which the bet is based has completed. If the event has completed, the bet undergoes bet verification process 820. On the other hand, if the event has not completed, the bet undergoes aggressive verification process 825. As used herein, bet verification is verification of the bet after the event upon which the bet is based has completed, while aggressive bet verification refers to a process by which verification is attempted while the event upon which the bet is based is still in progress.

As described herein, aggressive bet verification represents an improvement over existing bet verification techniques. Specifically, the aggressive bet verification as described herein provides improved speed and accuracy of the bet verification. For example, the techniques described herein allow for aggressive bet verification that compensates for potential statistical discrepancies that may exist from data received from a data provider.

First, assuming that the event upon which the bet is based has completed, the bet will undergo bet verification process 820. Bet verification process 820 begins in operation 830 where it is determined whether there is an outcome available for the bet. There may be instances where there is no outcome available for a bet even though the event upon which the bet is based has completed. For example, if the type of bet is a single player statistic bet, there will be no outcome for the bet if the player has no record of participating in the game. On the other hand, if the bet type is a player combined statistic, then there will be no outcome for the bet if either or both of the players associated with the bet has no record of participating in the game. Furthermore, if the bet is a head-to-head bet, then there will be no outcome to the bet if either or both players have no record of participating in the game. If there is no outcome for a particular bet, the bet is voided in operation 835. When a bet is voided, the wager associated with the bet may be returned to the user's account in, for example, accounting system 140 of FIG. 1.

If there is an outcome to the bet, bet verification process 820 continues to operation 832 where the bet is verified as a win or a loss for the user. For example, the bet can be verified as a win for the user if the following conditions are met:
If the bet type is a single player statistic bet or a player combined statistic bet, and the statistic condition upon which the bet is based is that the indicated statistic is at least a particular value, then the bet is a win for the user if the statistic value is greater than or equal to the particular value indicated in the bet.
If the bet type is a single player statistic bet or a player combined statistic bet, and the statistic condition upon which the bet is based is that the indicated statistic at most a particular value, then the bet is a win for the user if the statistic value is less than or equal to the particular value indicated in the bet.
If the bet type is a head-to-head bet between Player A and Player B, and Player A achieved a greater statistical value than Player B, then the bet is a win for the user.

When a bet is verified as a win, winnings are calculated for the bet in 833. Calculating the winnings may include, for example, multiplying the wager associated with the bet by the odds or offer associated with the bet. The results of the win calculation are then used to update a user's account through, for example, accounting system 140 of FIG. 1

On the other hand, the bet may be verified as a loss for the user if, for example, the following conditions are met:
If the bet type is a single player statistic bet or a player combined statistic, and the statistic condition upon which the bet is based is that the indicated statistic is at least a particular value, the bet is a loss for the user if the statistic value is less than the particular value indicated in the bet.
If the bet type is a single player statistic bet or a player combined statistic bet, and the statistic condition upon which the bet is based is that the indicated statistic at most a particular value, then the bet is a loss for the user if the statistic value is greater than the particular value indicated in the bet.
If the bet type is a head-to-head bet between Player A and Player B, and Player A achieved a lesser statistical value than Player B, then the bet is a loss for the user.

When a bet is verified as a loss, a user's account in, for example, accounting system 140 of FIG. 1 is updated in 834 to reflect the loss.

Returning to operation 815, if it is assumed that the event upon which the bet is based has not completed, the bet will undergo aggressive bet verification process 825. Aggressive bet verification begins in operation 840 where it is determined whether or not there is an outcome for a bet. Operation 840 may include running a process that queries database 115 for results which were parsed and stored in database 115. Operation specific 840 may then apply specific logic to compare the current statistical values associated with the bet against those indicated in the bet. For example, a bet is ready to be verified:
If the bet type is statistic bet, and the statistic condition upon which the bet is based is that the indicated statistic is at least a particular value, then the bet will be ready for verification if the current statistic value is greater than or equal to the particular value indicated in the bet. Of course, this logic may be specific to the sport, event, or statistical value upon which the bet is based. For example, this logic may not hold true for a bet based upon a running back achieving at least a certain number of rushing yards. Even if a running back achieves a certain number of yards, subsequent rushes by the player could results in a loss of yards, and therefore, this logic would be inappropriate to apply to such a bet.
If the bet type is statistic bet, and the statistic condition upon which the bet is based is that the indicated statistic is at most a particular value, then the bet will be ready for verification if the current statistic value is greater than the particular value indicated in the bet. As noted above, this logic may be specific to the sport, event, or statistical value upon which the bet is based, and may be inappropriate to apply to certain bets.

If the result is not available, the bet is returned to bet queue 805 in operation 845. If the result is available, the bet is marked as ready to be verified in operation 850. In operation 855, the process may wait a predetermined time interval, and verify again that the result is still available before performing the final verification. The waiting period of operation 855 may be used to avoid relying on any potential statistical discrepancies that may have existed from the data provider the first time the system downloads and parses the data. Accordingly, the waiting time for operation 855 may be set to be long enough for corrections to occur before finalizing the bet verification. According to some examples, the waiting time of operation 855 may be based upon the schedule of queue controller 605 of FIG. 6. For example, according to some specific examples, the waiting time of operation 855 may be one or more download cycles of a particular data set as scheduled by queue controller 605 of FIG. 6. If, after the waiting period of operation 855, the bet no longer has a result available, the bet is no longer marked as ready to be verified, and is returned to bet queue 805 through operation 845. If the bet is still verifiable after the waiting period of operation 855, the aggressive bet verification continues in operation 860. Operation 860 determines whether the bet is a win or a loss for the user.

Utilizing the predetermined time interval and re-verifying the results of a bet (e.g., as discussed in reference to operation 855 above) presents a technical problem that has no analog in the brick-and-mortar world. Furthermore, utilizing the predetermined time interval and re-verifying the results of a bet solves a problem that is necessarily rooted in computer technology, and addresses a problem uniquely arising in the realm of computer technology. Specifically, the use of the predetermined time interval addresses potential statistical discrepancies that may have existed from the data provider the first time the system downloads and parses the data, a problem introduced through the use of computer-verified bets, for which there is no analogue outside the realm of computer technology.

According to some example embodiments, aggressive bet verification may be limited to specific scenarios, including:
Verifying statistic bets in which the statistic condition upon which the bet is based is as at least a particular value as a win if the particular statistic value is greater than the value indicated in the bet.
Verifying statistic bets in which the statistic condition upon which the bet is based is at most a particular value as a loss if the particular statistic value is greater than the value indicated in the bet.

Upon determining whether or not the bet is a win or a loss, further steps may be taken by network controlled 125, including notifying the user through an API, such as API 120 of FIG. 1, updating an user's account in accounting system 140 of FIG. 1, updating a sportsbook via API 120 and sportsbook API 135 of FIG. 1, among others.

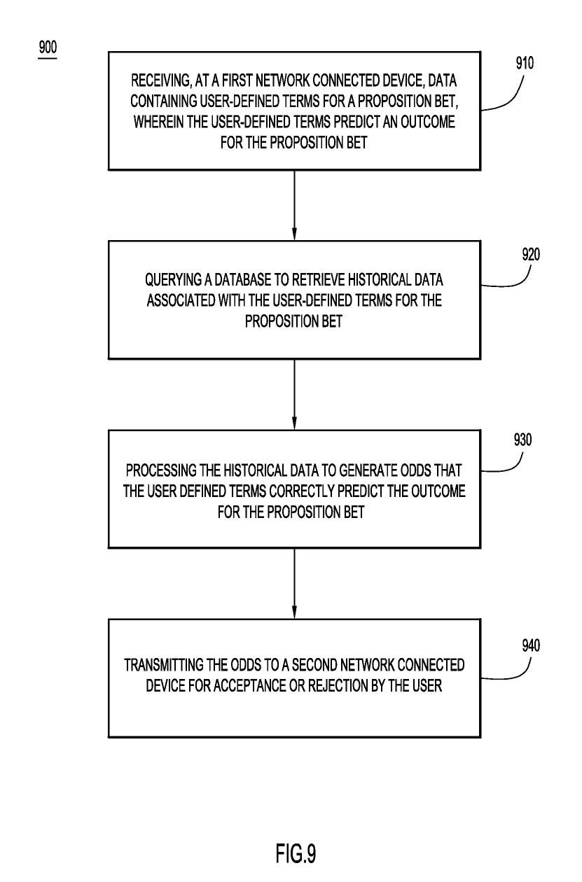

With reference now made to FIG. 9, depicted therein is a flowchart 900 illustrating a process for automatically generating and verifying proposition bets. According to example embodiments, the process of flowchart 900 may be carried out in an API, such as API 120 of FIG. 1. Furthermore, the operations illustrated in FIG. 9 may encompass one or more of the operations illustrated in FIGS. 4 and 6-8.

The process of flowchart 900 begins in operation 910 where data containing user-defined terms for a proposition bet are received at a first network connected device. The user-defined terms predict an outcome for the proposition bet. The user-defined terms may take the form of a performance condition for a proposition bet, where the performance condition has been customized by the user. Furthermore, the performance condition may predict the outcome for the proposition bet.

In operation 920, a database is queried to retrieve historical data associated with the user-defined terms for the proposition bet. For example, if the user-defined terms predict an outcome based upon a statistical performance of a particular player in an athletic competition, the database may be queried to retrieve historical data for that player with values associated with the statistical performance. According to one specific example, if the user-defined terms predict that “Player A” will pass for “X” yards in an upcoming NFL game, the database may be queried for Player A's previous passing stats in one or more NFL games. The user-defined terms may be the performance condition for the proposition bet, as described with reference to operation 910.

In operation 930, the historical data is processed to generate odds that the user-defined terms (e.g., the performance condition customized by the user) correctly predict the outcome for the proposition bet. For example, operation 930 may process the historical data as described above with reference to FIGS. 1 and 4. Finally, in operation 940, the odds are transmitted to a second network connected device for acceptance or rejection by the user. The second network connected device may, for example, display a user interface, such as user interface 110 of FIG. 1, that allows the user to generate the user-defined terms, receive the odds, and accept or reject the odds, as described above with reference to FIGS. 1-5C. The process of flowchart 900 may include further steps that allow automatic verification of the proposition bet through, for example, the operations illustrated in FIGS. 4 and 6-8.

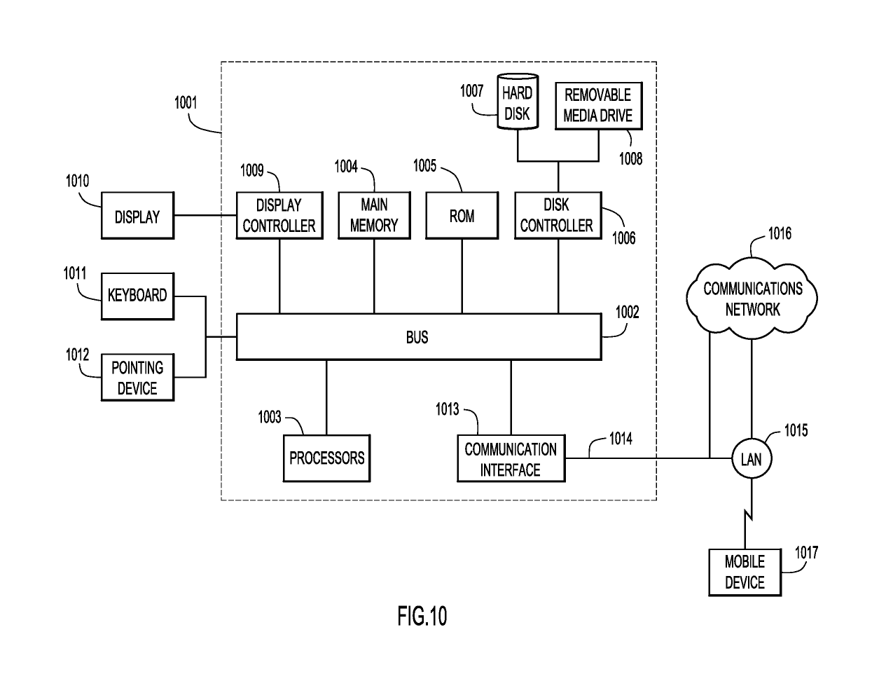

With reference made to FIG. 10, illustrated therein is a computer system 1001 upon which the embodiments presented may be implemented. The computer system 1001 may be programmed to implement a computer based device, such as a device displaying a user interface, such as user interface 110 of FIG.1, executing an API, such as one or more of APIs 120 or 135 of FIG. 1, executing an accounting system, such as accounting system 140 of FIG. 1, or operating as a network controller, such as network controller 125 of FIG. 1. The computer system 1001 includes a bus 1002 or other communication mechanism for communicating information, and a processor 1003 coupled with the bus 1002 for processing the information. While the figure shows a signal block 1003 for a processor, it should be understood that the processors 1003 represent a plurality of processing cores, each of which can perform separate processing. The computer system 1001 also includes a main memory 1004, such as a random access memory (RAM) or other dynamic storage device (e.g., dynamic RAM (DRAM), static RAM (SRAM), and synchronous DRAM (SD RAM)), coupled to the bus 1002 for storing information and instructions to be executed by processor 1003. In addition, the main memory 1004 may be used for storing temporary variables or other intermediate information during the execution of instructions by the processor 1003.

The computer system 1001 further includes a read only memory (ROM) 1005 or other static storage device (e.g., programmable ROM (PROM), erasable PROM (EPROM), and electrically erasable PROM (EEPROM)) coupled to the bus 1002 for storing static information and instructions for the processor 1003.

The computer system 1001 also includes a disk controller 1006 coupled to the bus 1002 to control one or more storage devices for storing information and instructions, such as a magnetic hard disk 1007, and a removable media drive 1008 (e.g., floppy disk drive, read-only compact disc drive, read/write compact disc drive, compact disc jukebox, tape drive, and removable magneto-optical drive). The storage devices may be added to the computer system 1001 using an appropriate device interface (e.g., small computer system interface (SCSI), integrated device electronics (IDE), enhanced-IDE (E-IDE), direct memory access (DMA), or ultra-DMA).

The computer system 1001 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 1001 may also include a display controller 1009 coupled to the bus 1002 to control a display 1010, such as a cathode ray tube (CRT) or a light emitting diode (LED) display, for displaying information to a computer user. The computer system 1001 includes input devices, such as a keyboard 1011 and a pointing device 1012, for interacting with a computer user and providing information to the processor 1003. The pointing device 1012, for example, may be a mouse, a trackball, or a pointing stick for communicating direction information and command selections to the processor 1003 and for controlling cursor movement on the display 1010. The pointing device 1012 may also be incorporated into the display device as, for example, a capacitive touchscreen and/or a resistive touchscreen. In addition, a printer may provide printed listings of data stored and/or generated by the computer system 1001.

The computer system 1001 performs a portion or all of the processing steps of the invention in response to the processor 1003 executing one or more sequences of one or more instructions contained in a memory, such as the main memory 1004. Such instructions may be read into the main memory 1004 from another computer readable medium, such as a hard disk 1007 or a removable media drive 1008. One or more processors in a multi-processing arrangement may also be employed to execute the sequences of instructions contained in main memory 1004. In alternative embodiments, hard-wired circuitry may be used in place of or in combination with software instructions. Thus, embodiments are not limited to any specific combination of hardware circuitry and software.

As stated above, the computer system 1001 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 1001, for driving a device or devices for implementing the invention, and for enabling the computer system 1001 to interact with a human user (e.g., print production personnel). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 1001 also includes a communication interface 1013 coupled to the bus 1002. The communication interface 1013 provides a two-way data communication coupling to a network link 1014 that is connected to, for example, a local area network (LAN) 1015, or to another communications network 1016 such as the Internet. For example, the communication interface 1013 may be a wired or wireless network interface card to attach to any packet switched (wired or wireless) LAN. As another example, the communication interface 1013 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1013 sends and receives electrical, electromagnetic or optical signals that carry digital data streams representing various types of information.

The network link 1014 typically provides data communication through one or more networks to other data devices. For example, the network link 1014 may provide a connection to another computer through a local are network 1015 (e.g., a LAN) or through equipment operated by a service provider, which provides communication services through a communications network 1016. The local network 1014 and the communications network 1016 use, for example, electrical, electromagnetic, or optical signals that carry digital data streams, and the associated physical layer (e.g., CAT 5 cable, coaxial cable, optical fiber, etc.). The signals through the various networks and the signals on the network link 1014 and through the communication interface 1013, which carry the digital data to and from the computer system 1001 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1001 can transmit and receive data, including program code, through the network(s) 1015 and 1016, the network link 1014 and the communication interface 1013. Moreover, the network link 1014 may provide a connection through a LAN 1015 to a mobile device 1017 such as a personal digital assistant (PDA) laptop computer, or cellular telephone.

The above description is intended by way of example only.

What is claimed is:

1. A method comprising:
receiving, at a first network connected device, data containing a performance condition for a proposition bet customized by a user; wherein the performance condition predicts an outcome for the proposition bet;
querying a database to retrieve historical data associated with the performance condition for the proposition bet;
processing the historical data to generate odds that the performance condition correctly predicts the outcome for the proposition bet; and
transmitting the odds to a second network connected device for acceptance or rejection by the user.

2. The method of claim 1, further comprising:
receiving from the second network connected device data indicating acceptance of the odds;
querying a second database to retrieve data indicating the outcome for the proposition bet; and
processing the data indicating the outcome for the proposition bet to determine the outcome.

3. The method of claim 2, wherein the database and the second database are the same database.

4. The method of claim 2, wherein the performance condition comprises a statistical value achieved by a participant in a competitive event.

5. The method of claim 2, wherein querying the second database comprises querying the second database prior to a completion of a competitive event; and
processing the data indicating the outcome for the proposition bet comprises processing the data indicating the outcome for the proposition bet prior to completion of the competitive event.

6. The method of claim 5, wherein querying the second database comprises querying the second database a first time prior to the completion of the competitive event and querying the second database a second time prior to the completion of the competitive event after a predetermined time interval; and
wherein processing the data indicating the outcome for the proposition bet comprises processing results of querying the second database the first time to determine the outcome for a first time, and processing results of querying the second database the second time to determine the outcome for a second time.

7. The method of claim 2, wherein querying the second database comprises querying the second database subsequent to a completion of a competitive event.

8. An apparatus comprising:
a network interface configured to send and receive network flows over a network; and
a processor configured to:
receive data containing a performance condition for a proposition bet customized by a user; wherein the performance condition predicts an outcome for the proposition bet;
query a database to retrieve historical data associated with the performance condition for the proposition bet;
process the historical data to generate odds the performance condition for the proposition bet correctly predict the outcome for the proposition bet; and
transmit the odds to a network connected device for acceptance or rejection by the user.

9. The apparatus of claim 8, wherein the processor is further configured to:
receive from the network connected device data indicating acceptance of the odds;
query a second database to retrieve data indicating the outcome for the proposition bet; and
process the data indicating the outcome for the proposition bet to determine the outcome.

10. The apparatus of claim 9, wherein the database and the second database are the same database.

11. The apparatus of claim 9, wherein the outcome for the proposition bet comprises a statistical value achieved by a participant in a competitive event.

12. The apparatus of claim 9, wherein the processor is configured to query the second database prior to a completion of a competitive event; and
wherein the processor is configured to process the data indicating the outcome for the proposition prior to completion of the competitive event.

13. The apparatus of claim 12, wherein the processor is configured to query the second database a first time prior to the completion of the competitive event and query the second database a second time prior to the completion of the competitive event after a predetermined time interval; and
wherein the processor is configured to process results of querying the second database the first time to determine the outcome for a first time, and process results of querying the second database the second time to determine the outcome for a second time.

14. The apparatus of claim 9, wherein the processor is configured to query the second database subsequent to a completion of the competitive event.

15. One or more non-transitory computer readable storage media encoded with software comprising computer executable instructions and when the software is executed operable to cause a processor to:
receive data containing a performance condition for a proposition bet customized by a user; wherein the performance condition predicts an outcome for the proposition bet;
query a database to retrieve historical data associated with the performance condition for the proposition bet;
process the historical data to generate odds that the performance condition for the proposition bet correctly predict the outcome for the proposition bet; and
transmit the odds to a network connected device for acceptance or rejection by the user.

16. The one or more non-transitory computer readable storage media of claim 15, wherein the instructions further cause the processor to:
receive from the network connected device data indicating acceptance of the odds;
query a second database to retrieve data indicating the outcome for the proposition bet; and
process the data indicating the outcome for the proposition bet to determine the outcome.

17. The one or more non-transitory computer readable storage media of claim 16, wherein the database and the second database are the same database.

18. The one or more non-transitory computer readable storage media of claim 16, wherein the outcome for the proposition bet comprises a statistical value achieved by a participant in a competitive event.

19. The one or more non-transitory computer readable storage media of claim 16, wherein the instructions further cause the processor to query the second database prior to a completion of the competitive event; and
wherein the instructions further cause the processor to process the data indicating the outcome for the proposition prior to completion of the competitive event.

20. The apparatus of claim 19, wherein the instructions further cause the processor to query the second database a first time prior to the completion of the competitive event and query the second database a second time prior to the completion of the competitive event after a predetermined time interval; and
wherein the instructions further cause the processor to process results of querying the second database the first time to determine the outcome for a first time, and process results of querying the second database the second time to determine the outcome for a second time.
